(19) United States
(12) Patent Application Publication
(10) Pub. No.: US 2016/0055331 A1
(43) Pub. Date: Feb. 25, 2016

(54) DETECTING EXPLOITS AGAINST SOFTWARE APPLICATIONS

(71) Applicant: IRDETO B.V., Hoofddorp (NL)

(72) Inventor: Andrew Szczeszynski, Beijing (CN)

(21) Appl. No.: 14/780,120

(22) PCT Filed: Mar. 28, 2013
(86) PCT No.: PCT/CN2013/073388

§ 371 Date: Sep. 25, 2015

(51) Int. Cl. G06F 21/54

(52) U.S. Cl. CPC G06F 21/54; G06F 2221/033

(57) ABSTRACT

There is described a method of executing a software application on a device by including a secured cored within the software application, and providing a system verification function within the secured core. The system verification function is used to scan for exploits against the application, for example local exploits seeking to recover cryptographic keys which may be found within the application when executing, with reference to exploit signature data which may be provided by an external server.

### FIELD OF THE INVENTION

The invention relates to methods and apparatus for executing software applications on devices which enable exploits against the software applications to be detected and defeated, and devices and systems arranged to carry out the methods.

### BACKGROUND OF THE INVENTION

When trying to protect a software application on a computing device from tampering, security may only be as good as the weakest attack path. A software application can usually be attacked using many different techniques and paths, some of which may not have been thought of when the software was initially designed and written. Attackers will tend to follow the easiest attack path, and often will invent new paths rather than attack well protected paths. Usually some core of the software application can be protected very well, to the point that attackers are unwilling or unable to attack it, or for which an attack would take a sufficiently long time. However, outside of this core, relatively simple attack paths may exist that leave the software application vulnerable. These attack paths may be known to the designers and providers of the software application, but may be difficult to protect sufficiently.

Consider for example a situation where a software application must use a dependent library to which it sends security critical data. In the prior art, the integrity of the software application and the libraries it uses may be achieved using anti-tampering detection, such as Integrity Verification (IV), in which the software application and dependent libraries are signed with a signing tool which generates cryptographically secure signatures. Sometime during start up or execution (traditional IV check), or just before each critical procedure call (which can be referred to as a secure call), the signatures of code segments are verified, either on disk (or other persistent storage) or in memory or both. If the signatures are correctly verified, the software application has confirmation that its code has not been tampered with and execution continues as it should. If the signatures are not verified, the software application has an indication that a code segment has been modified and that execution will therefore likely fail or follow a different execution path to that originally designed and intended, and can therefore take preventative measures such as blocking execution. These checks, especially if well hidden and integrated into the software application product, make it very difficult for attackers to change the computer program code of the software application.

Traditional anti-tampering checks and secure calls require that the binaries of the dependent libraries of the software application are available for signing before the application is deployed to the computing device. If the libraries are not available to the developer or it is impractical to obtain them, then signatures cannot be calculated and the technique fails. This can occur, for instance, if a library is being provided and deployed separately by a myriad of different parties and where each party is free to implement and update the library differently, such as is the situation with many libraries for handheld device manufacturers. It is then often difficult or impossible to communicate with all parties and obtain a copy of their library, and it is often impossible to obtain updates to the library in good time before they are deployed. Therefore, even though a software application itself can be well protected from tampering, if no anti-tampering techniques can be used on the dependent libraries, then a hacker can simply replace those libraries with their own and attack the software indirectly, for example to siphon critical data.

The invention addresses problems and limitations of the related prior art.

### SUMMARY OF THE INVENTION

The invention provides an anti-tampering scheme in which a software application checks for the presence of known exploits, and is particularly applicable where the software application is implemented on a large user base of computer devices. Typically, signatures of the known exploits are frequently updated on each computer device from some external central source. On each computer device, the detection process is integrated into a well-protected area of the software application, generally referred to herein as a secured core. In this way, known exploits can be quickly stopped thus preventing those exploits from affecting a significant percentage of the user base, rather than attempting to stop all attacks. By itself, the invention does not necessarily stop new exploits from being developed (although advanced heuristics within, in combination with, or additional to the signatures may be able to detect exploits that are being developed), but rather prevents such exploits from being effectively distributed in a widespread manner.

The invention provides for execution of a software application on a device by including a secured core within the software application, and providing a system verification function within the secured core. The system verification function is used to scan for exploits against the application, for example local exploits seeking to recover cryptographic keys which may be found within the application when executing, with reference to exploit signature data which may be provided by an external server.

In particular, the invention provides a method of executing a software application on a device, the method comprising steps of: providing the software application with a secured core; receiving, at the device, exploit signature data from a source external to the device; and executing a system verification function within the secure cored, the system verification function being arranged to detect exploits against the software application using the exploit signature data.

The device may be a mobile computing device such as a mobile telephone, a tablet computer or similar.

The exploit signature data and/or the system verification function may be configured such that scanning is carried out only for local exploits against the software application, in which an otherwise legitimate user of the device is engaged in exploits against aspects of the software application such as trying to recover cryptographic data such as cryptographic keys. The system verification function, in combination with the exploit signature data, may also be arranged to scan only for exploits against the software application, and not for exploits against other software applications.

The software application may be arranged such that using an exploit to bypass the system verification function causes a limitation in the user functionality of the software application, for example preventing the application from carrying out its primary user function (for example preventing playback of content such as video and/or audio content if the software application is a media player).

Typically, the software application may be arranged to make procedure calls to one or more library functions which are installed on the device but which are external to the software application itself. The software application may then be arranged to perform a scan for exploits before completing a procedure call to an external library function and to block completion of said procedure call if an exploit against the software application is detected by the scan, for example if an exploit which has modified or swapped the library is detected of it an exploit which snoops on the procedure call is detected.

The system verification function may be arranged to perform a scan for exploits against the software application before decrypting selected data required by the software application, and to block completion of said decryption if an exploit against the software application is detected by the scan. Such data could include program code required for execution of the software application.

The exploit signature data may typically be received at the device as at least one exploit signature file, for example from a server by a push mechanism initiated by the server or a pull mechanism initiated by the device, and this may occur periodically and be required to do so according to predetermined constraints. The exploit signature data may be encrypted within the received exploit signature file, and the system verification function may then be arranged to decrypt the exploit signature data before or during use to carry out a scan for exploits.

The exploit signature file may also comprise a time stamp or other time data, for example certifying the time of creation or delivery of the file to the device. The software application, or the system verification function in particular may then be arranged to determine whether or not to use the exploit signature data contained within the exploit signature file dependent upon the time stamp. For example, the file may be rejected if the time stamp is too old. To prevent tampering with this process, a secure clock may be used in the device to determine if the time stamp meets particular criteria.

The exploit signature file may also comprise a digital signature, and the system verification function may then be arranged not to use a received exploit signature file if the digital signature fails verification by the software application or the system verification function.

The exploit signature data may also provide the system verification function with one or more algorithms for use in scanning for said exploits, for example by providing complete code to execute a particular algorithm, or by providing partial code and/or data to complete the definition of an algorithm to be executed.

The invention may also provide a method of executing at least one software application installed on a computer device, comprising: receiving, at the device, exploit signature data from a source external to the device; and executing a system verification function on the computer device to scan for exploits against at least one of the at least one software application. In this way, a single system verification function can be used to scan for exploits against a plurality of software applications. This arrangement can be carried out in accordance with the various method aspects already discussed above. In this arrangement, the system verification function may execute outside of all of the software applications for which exploits against are to be scanned, for example within a secured environment on the device, or could for example execute within a secured core of one application but scan for exploits against that same and/or other applications.

The invention also provides apparatus corresponding to the above methods, for example a computer device comprising:

a software application provided with a secured core; and

a system verification function arranged to execute within the secured core of the software application to scan for exploits against the software application,

the computer device being arranged to receive exploit signature data from a source external to the device, the system verification function being arranged to use the exploit signature data to scan for said exploits.

The invention also provides a software application corresponding to the described methods and apparatus, for example comprising a secured core and a system verification function arranged to execute within the secured core as set out above, and corresponding computer readable media, for example a computer readable medium carrying computer program code arranged to put such a software application into effect on a computer device.

### BRIEF DESCRIPTION OF THE DRAWINGS

Embodiments of the invention will now be described, by way of example only, with reference to the accompanying drawings of which:

FIG. 1 illustrates a computer device in which a system verification module operates within a secured core of a software application to scan for exploits, and mechanisms for delivering exploit signature data to the device;

FIG. 2 illustrates steps carried out to operate the arrangement of FIG. 1;

FIG. 3 shows how exploit signature data may be generated and made available to devices;

FIG. 4 illustrates aspects of an exploit signature file;

FIG. 5 shows an arrangement in which a system verification module is implemented to scan for exploits against multiple software applications in a device; and

FIGS. 6 and 7 illustrate ways in which the secured core may be implemented using software techniques.

### DETAILED DESCRIPTION OF EMBODIMENTS OF THE INVENTION

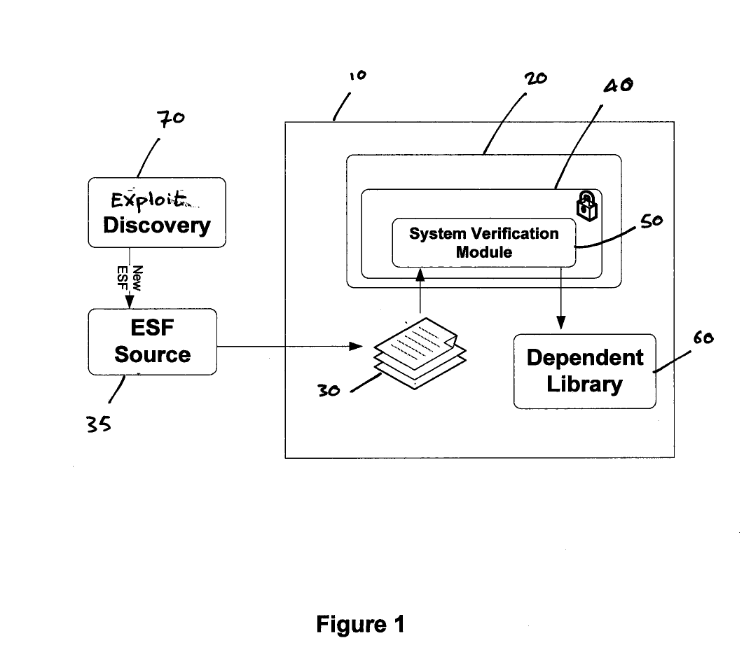

Referring now to FIG. 1, a computer device 10 is arranged to execute a software application 20. The computer device may be, for example, a traditional personal computer, a tablet computer, a mobile telephone or other mobile device, and so forth. The invention is typically implemented on a large user base of such computer devices. A software application 20 may typically be stored on a hard disk drive, a solid state disk or in some other form of persistent memory, for loading into random access memory of the computer device 10 in preparation for execution.

It is known for attackers to try to attack software applications. This may involve, for example, reverse engineering the corresponding executable file and/or modifying the executable file in order to gain access to features/functionality and/or information that may not normally be available to the attacker. For example, the attacker may not have paid for access to certain functionality of the application (e.g. if the attacker has not obtained a suitable licence for that functionality)—the instructions for carrying out that functionality may exist in the executable file for the software application to which the attacker has access, but the attacker is not provided access to, or authorization to execute, those instructions, in which case the attacker may carry out an attack to try to circumvent protection mechanisms in place (e.g. authorization or licence checking) in order to be able access that functionality by executing those instructions. Once an attacker has successfully attacked the executable file, the attacker may form an attacked version of the executable file that enables unauthorised access to the protected functionality—the attacker may then distribute this attacked version of the executable file, thereby allowing other people to access this protected functionality. Similarly, an attacker may attack an executable file in order to generate an attacked version of the executable file that includes additional malware functionality—the attacker may then distribute this attacked version of the executable file, and, if a recipient runs the attacked version of the executable file, the recipient may end up running the malware component.

The computer device 10 is therefore arranged to download exploit signature data, for example in the form of an exploit signature file (ESF) 30, from an external source 35. The external source typically delivers an updated ESF 30 to the computer device 10 periodically, for example in a push type operation or on request from the device 10 or software application 20. In this way, the ESF can be kept up to date to reflect changed and new exploits identified by an exploit discovery group 70 which is a body or organisation responsible for discovering and preventing new exploits on the software application 20 and for updating the ESF to enable the software application 20 to detect these exploits. In particular, the ESF 30 may identify exploits against the software application 20 which are perpetrated by a legitimate user of that application 20 or of the computer device 10, which may be referred to as a local exploit. For example, the ESF may identify exploits aimed at obtaining key data or other information which can be used to defeat content protection systems, digital rights management systems and similar.

The ESF 30 contains the signatures of known exploits on the software application 20. The signature data contains information on how to detect particular exploits, for example with a signature providing information for detecting one or several similar exploits.

The software application 20 detects exploits using a system verification function or system verification module (SVM) 50 integrated into the software application 20 in such a way that bypassing the system verification function would prevent the application from performing at least a significant or major part of its function. In particular, the SVM 50 executes within a secured core 40 of the software application 20, which is a well-protected area in the software application 20.

A secured core may be provided in various ways including by running a part of the application in a secured hardware element, for example on a separate microprocessor, and by using secured software components. The ARM Trustzone is an example of a technology that can be used to create such a secured core (described at:

“http://en.wikipedia.org/wiki/ARM_architecture#Security_{—} Extensions_{—}.28TrustZon e.29”).

A similar concept is described in EP2362573, which is hereby incorporated by reference, and in which an electronic device comprises a secured portion and a non-secured portion. The secured portion comprises a memory for secure storage of data, such as a trust key and a session key. The secured portion is a dedicated part of the computer device and contains hardware elements not allowing access by means of read/write operations of data from outside the secured portion and only allowing data transfer with non-secured portions of the receiver in encrypted form. An example of a secured portion in EP2362573 is a secured crypto-engine.

Other ways of providing a secured core are set out in PCT/EP2012/004267, which is also hereby incorporated by reference. This patent application describes modern chips and how they are configured during the manufacturing process, and discusses the use of some part of the chip to execute software without its operation being accessible to any other software executing on the device nor is its internal memory accessible via the hardware pins of the chip. Attackers would therefore need to open the device and use probes to observe the software.

A secured core can be provided using secured software components, for example in which software transformations are applied that radically modify the control flow and the data flow of computer programs. One example is the whitebox AES technology discussed in “White-Box Cryptography and an AES Implementation”, by Stanley Chow, Philip Eisen, Harold Johnson, and Paul C. Van Oorschot, in Selected Areas in Cryptography: 9^{th} Annual International Workshop, SAC 2002, St. John's, Newfoundland, Canada, Aug. 15-16, 2002, the entire disclosure of which is incorporated herein by reference. “White-Box Cryptography and an AES Implementation” discloses an approach to protecting the integrity of a cryptographic algorithm by creating a key-dependent implementation of the algorithm using a series of lookup tables. The key(s) are embedded in the implementation by partial evaluation of the algorithm with respect to the key(s). Partial evaluation means that expressions involving the key are evaluated as much as reasonably possible, and the result is put in the code rather than the full expressions. This means that the implementation is specific to particular key(s) and that key input is unnecessary in order to use the key-dependent implementation of the algorithm. It is therefore possible to distribute a key-dependent implementation of an algorithm, which may be user-specific, for encrypting or decrypting content or data instead of distributing keys, which may be user-specific. The key-dependent implementation is created so as to hide the key(s) by: (1) using tables for compositions rather than individual steps; (2) encoding these tables with random bijections; and (3) extending the cryptographic boundary beyond the cryptographic algorithm itself further out into the containing application, thereby forcing attackers to understand significantly larger code segments to achieve their goals. A more recent discussion is found in PCT/EP2013/056617, also incorporated herein by reference, in which data is transformed using an error correcting code and operations on the data are performed in the error corrected data domain, such that after each operation on the data the error correcting code remains intact.

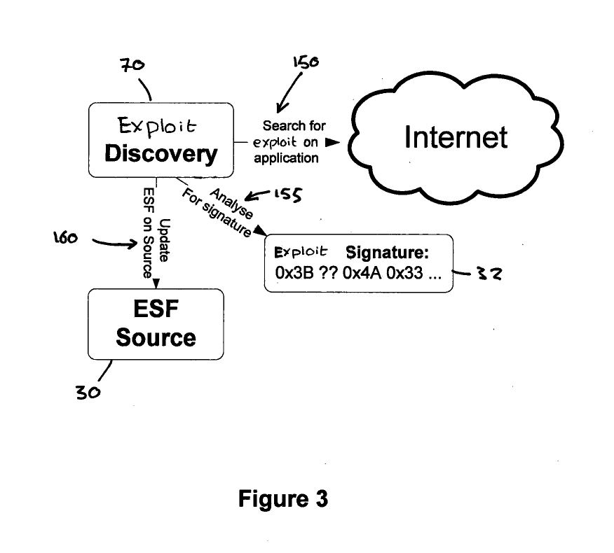

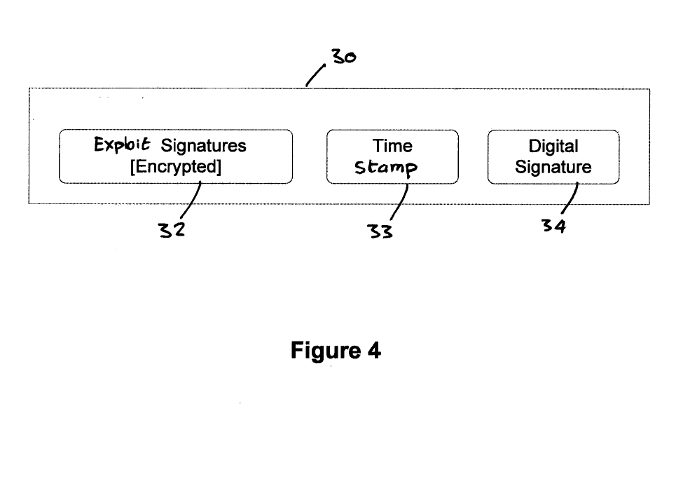

Other ways of implementing a secured core using secured software components are set out in PCT/EP2013/056615, also incorporated herein by reference. For example, see pages 8-17 and FIGS. 3 and 4 of this document, and the corresponding material set out towards the end of the present detailed description. These software techniques use a mixture of mathematical techniques that transform data using a transformation that approaches the strength of encryption, but still permitting operations on the transformed data produce valid results after removing the transformations.

The above techniques tend to produce transformed software code which is relatively inefficient, but which is very hard to reverse engineer without knowledge of the basic parameters used to generate the transformed code. Due to the runtime inefficiencies, it is impractical to apply such techniques to entire software applications, but it is feasible to apply them to a subsection of the application, i.e a secured core, that contains the more critical security functions of an application.

The SVM 50 uses the ESF 30 to scan for known exploits. The SVM 40 can preferably examine a wide range of properties of the computing device, including searching random access and persistent memory for particular byte sequences, observing device resources such as memory, CPU usage, or IO, and looking at system call patterns.

FIG. 1 also shows an exemplary dependent library 60 installed in the computer device 10 and which provides functionality required by the application.

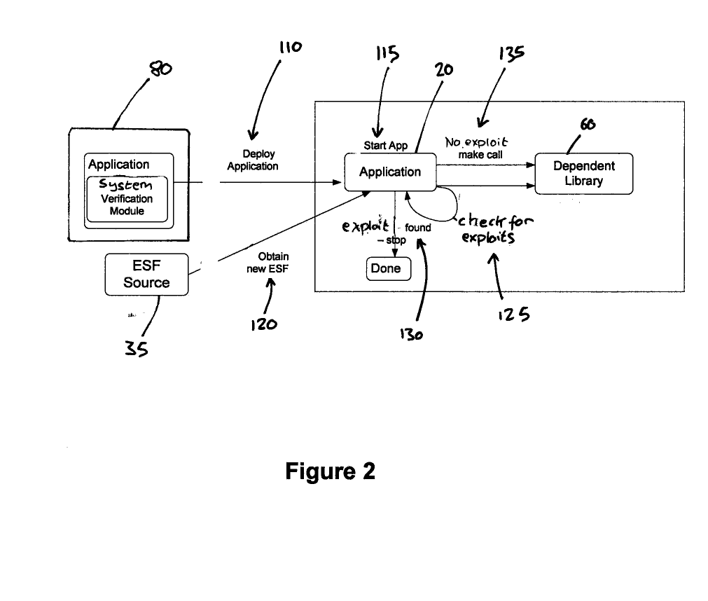

FIG. 2 shows how the arrangement of FIG. 1 may operate to protect the software application 20 from exploits. The software application 20 integrates securely the SVM 50, which is run at start up and during execution of the software application 10. During execution, for example, the SVM 50 may be run before important calls to one or more dependent libraries 60 to verify that known exploits are not being used.

In FIG. 2, step 110 illustrates deployment of the application 20 to the computer device 20, for example from an application developer or other application source 80. The application may be deployed, for example following download over a network or installation from a computer readable medium, with or without the newest ESF 30 being provided at that time. Each time the application is run at step 115 the SVM 50 (not shown in FIG. 2) is also started. The SVM then examines the ESF 30 and verifies that it is authentic and current. If not authentic or current, a new version of the ESF may be obtained by the device at step 120.

The software application may be configured so as not to continue until a verified and current ESF is available at the device 10. When run at step 125, the SVM verifies that no known exploits are being performed, using signature information contained within the ESF. If an exploit is found, the application 20 is stopped or partially stopped from performing its function at step 130. If no exploits are found, it enables the application 20 to continue as normal, for example in making calls to the dependent library as shown in step 135.

In the meantime, as shown in FIG. 3, the exploit discovery group or entity 70 continues to scan for exploits on the application as implemented in the wider user base in step 150, for example through Internet connections to computer devices 10 which have implemented the software application and which have been identified as having been compromised. When a new exploit is found, it is analyzed by the exploit discovery group 70 at step 155 for an exploit signature 32, and the exploit signature data, for example in the form of the ESF 30 is updated at step 160 on the ESF Source 35 to include the new signature 32.

The scheme described above has a number of advantages:

For an exploit to be effectively deployed, it must disable the SVM 50. If SVM is not disabled then the attack discovery group 70 can deploy a new signature to disable the exploit. This forces the attacker to defeat the secured core 40 which is typically the most secure part of the application;

It is not necessary for all potential exploits and exploit paths to be known before deployment of the software application 20;

The application 20 can scan all dependencies of the software application, including dependent libraries 60 and data files, for exploits;

Often signatures for an exploit can be found that are difficult for attackers to change, making it difficult for attackers to adapt;

The activity of the SVM in scanning for exploits can be fast because the number of signatures can be kept low. This is because only exploits that affect the software application 20 itself need be detected, with exploits affecting other software executing on the computer device 10 being ignored. This may have the advantage that scans can be run more often;

Because the software application 20 can require that a relatively new version of the Exploit Signature File is used, updates to the Exploit Signature File can quickly take effect across a large user base of the software application 20 on many devices.

When compared with prior art software used for scanning for viruses on computer systems, embodiments of the present invention have many differences including the following:

The SVM is integrated into the software application itself rather than running standalone or separately;

Rather than scanning for exploits by hackers from outside the computer device, the SVM may scan for exploits perpetrated by a user of the computer device 10 against the software application 20 (local exploits);

The SVM may be integrated into the software application 20 so that a successful scan (where no exploits are found) is integral to the application 20 running correctly;

The SVM need only scan for exploits targeting the software application into which it is integrated, rather than scanning for all exploits that can target the computer device in general.

As discussed above, the system verification module 50 is integrated tightly into the software application 20 so that it is difficult to circumvent the scans carried out by the SVM. This can be done a number of ways, for example:

(a) encrypting data which is required or critical for the functioning of the software application 20, either before deployment or sometime during run-time, but before a scan carried out by the SVM, then decrypting that data as a result of a successful scan;

(b) by integrating scans by the SVM into procedure calls made by the software application 20, especially into those that call dependent libraries 60, such that a failed scan will prevent the procedure call from being made or completed, so that critical data is not passed to those procedure calls;

(c) by using obfuscation techniques such as control flow flattening and traditional anti-tampering checks within the software application 20 itself;

(d) by integrating anti-debugging techniques into the software application 20;

(e) by the SVM performing at least some scans from one or more privileged processes or trusted execution environments.

By the SVM 50 scanning for exploits, a successful scan (one where no exploits are detected) can therefore result in encrypted data being unencrypted, or the functional call being made successfully. In this manner, should an attacker cause the software application 20 to skip a scan by the SVM, the encrypted data will not be unencrypted or the function call will not performed, and the software application will therefore fail to run correctly.

The SVM 50 can use many different techniques during its scans for detecting exploits, for example techniques similar to those found in prior art virus scanners. Files on disk and memory can be scanned for particular byte patterns. Files relating to the software application 20, including data files, as well as system files and dependent library files could be scanned. Application binary code, as well code running in scripted environments such as JavaScript, can be scanned and protected. System attributes, such as CPU performance patterns, disk usage patterns, and network bandwidth usage could be monitored by the scans. System call patterns can be used to look for particular traits exhibited by attacks. Statistics about known good libraries, such as size, byte patterns, or partial signatures, can be used to help increase accuracy on scans.

Any one particular type of information mentioned above may not by itself give rise to an accurate detection of an exploit, but different information types may be used in combination to improve accuracy. A particular signature contained within the ESF 30 may include many conditions for a positive recognition. Conditions such as AND (e.g. A AND B must be true), OR (e.g. A OR B must be true), NOT (e.g. A AND B but NOT C must be true), choice (e.g. 3 or more of A,B,C,D,E must be true), or floating-point values (e.g. 20% of A+35% of B+10% of chi-squared(C) over 1 month must be less than 1.0) could be used. The SVM should be used to scan sometime during or after start up of the software application 20 and before important procedure calls, especially to dependent or external libraries.

A signature may require a test or check to be made in more than one place (for example a byte sequence in a first file and in a second procedure call) to make it more difficult for an attacker to circumvent the scans. Note that many exploits can be started after the software application 20 has been running for some time, so it is important that exploits scans are carried out periodically as the application runs. Such scans may optimally be executed in multiple threads to make the timing of the scans more difficult to detect by attackers and exploits, and to make the scans more difficult to stop by an attacker or exploit. When a file or library has been successfully scanned, a signature or hash of the file or library may be calculated and stored so that until such time as a new ESF is obtained or the signature or hash changes, further scanning may not be required on the file or library.

An attacker may try to subvert the mechanisms by which the SVM gathers information during its scans, for example by subverting system calls or file accesses. To counter this possibility, the SVM may randomize how it gathers information. The SVM may also gather known and immutable attributes of the system. If these attributes are changed or incorrect, then the SVM may be able to deduce that it is the subject of an attack or exploit itself.

Although the Exploit Signature File 30 contains signatures defining exploits which may be detected during a scan, such as instructions for what byte patterns to search for and where, it may also contain time information specifying when it was generated and/or delivered. An example of an exploit signature file 30 is illustrated in FIG. 4. The ESF 30 contains exploit signatures 32 which in the embodiment of FIG. 4 are encrypted, a time stamp 33 indicating when the ESF was generated or delivered, and a digital signature 34 which the SVM 50 can use to verify the ESF 30.

The SVM may verify that the ESF 30 is current, or that it satisfies one or more time constraints. For instance, the SVM could require that the ESF must have been created or delivered within a certain time period for example being no more than one week old, and if not then the software application 20 may cease being fully functional until a new ESF satisfying the same or a different time constraint is acquired. Such a mechanism may be critical in ensuring that when a new exploit is identified by the attack discovery group 70, all users will be required to obtain an updated ESF with a signature for recognising the new exploit within a reasonable time period. In the meantime the new exploit may be effective against users with an old ESF. An attacker could tamper with a relevant clock in the computer device 10, thus allowing an old ESF to be used, and to avoid this the computer device 10 may include a secure clock to prevent clock rollbacks or system clock tampering.

The exploit signature file is preferably also protected from discovery so as to inhibit attackers from gaining valuable information as to how their exploits are being discovered and scanned for, because such information could be used to quickly adapt to make new exploits less detectable by the SVM. Protection of the ESF 30 can be performed by encrypting the file in some way using a secret key and using the file in a transformed state within the application. The ESF is preferably also protected from tampering, otherwise attackers could make changes for example such that the ESF searches for the wrong signatures, or they could change time information thus allowing an old ESF to be used. The ESF can be protected from tampering by having the file digitally signed using a cryptographically secure method, such as using a digital signature 34 for example an RSA signature, and requiring the SVM to verify the signature 34. Further tamper protection could be achieved by the SVM being arranged to consider only certain values of the time stamp 33 to be valid, for example by being divisible by a particular number, or by being the closest value of some predefined mathematical progression, such that a value outside the allowed range would imply the ESF is not authentic and should be rejected.

To improve the versatility of the SVM in carrying out scanning, the ESF may contain code, for example in the form of a shared library or dynamic link library, that contains routines that may be referenced by some signatures 32. In this fashion, if the existing scanning techniques integrated into the SVM are not sufficient to correctly identify an exploit, new or modifications to existing techniques can be distributed as part of the ESF. Such code is preferably digitally signed and protected to ensure attackers cannot use this functionality to make modifications to the code or to execute their own code, or to analyze how exploits are detected.

The software application 20 preferably incorporates a method to obtain the newest Exploit Signature File frequently so that exploits can be stopped before they affect a significant portion of the user base of computer devices 10 implementing the software application 20. One way of achieving this is for the ESF to be delivered from the ESF Source 35 to the software application 20 using an Internet connection, with the software application requiring that it has access to the Internet frequently enough. The ESF source 35 could be implemented using a server, such as an HTTP server, that hosts updated exploit signature files, and the software application could be required to pull the updated ESFs from the server. In addition, updated ESFs could be broadcast to the instances of the software application deployed on the many computer devices of a user base. The software application 20 may be arranged such that, should it fail to obtain an ESF that is considered sufficiently new, the application will cease carrying out its primary function until the application has been able to connect to the ESF Source 35 to obtain an updated ESF. To minimise the chances of an ESF becoming out of date on a particular computer device 10, the application should be arranged to frequently try to obtain a newer ESF file even if the current one is not considered too old.

When a computer device 10 requests an exploit signature file 30, the ESF source 35 may return the most up-to-date ESF version incorporating a corresponding time stamp. The exploit discovery group 70 is able to maintain the ESF source 35 to hold the most up-to-date ESF as new exploits are discovered. An automated script could be used by the ESF source to write a contemporaneous time stamp 33 and digitally sign the most recent ESF as delivered from the exploit discovery group 70. Such time stamping and digital signing must be done frequently enough so that new exploit signatures are quickly delivered to the computer devices. However, care must be taken to make each newly updated ESF sufficiently different from previous versions that an attacker who collects the updated ESF files cannot gain information due to the only or only significant difference between two particular versions being the time stamp 33. To help avoid this risk, some randomness, such as dummy random values inserted into the ESF, random layout of the ESF, or random keys inserted into the ESF, may be used to reduce the risk of successful brute force attacks on the encryption keys and other aspects of the ESF.

The attack discovery group 70 could include a group of people who regularly scan the Internet for information posted about exploits, and/or could comprise a series of automated tools that perform the same or a similar function. When an exploit has been found, it is analyzed for signatures and patterns that can be used to detect it. It is important that when a signature is generated, it correctly identifies the exploit and does not result in many false-positives which would lead to frustration and a poor experience for users of the software application. When a new signature has been constructed, the ESF is updated at the ESF Source to include the new signature. Note that though some exploits may target more than one different software application 20, the ESF 30 preferably contains only signatures of exploits targeting the corresponding software application 20.

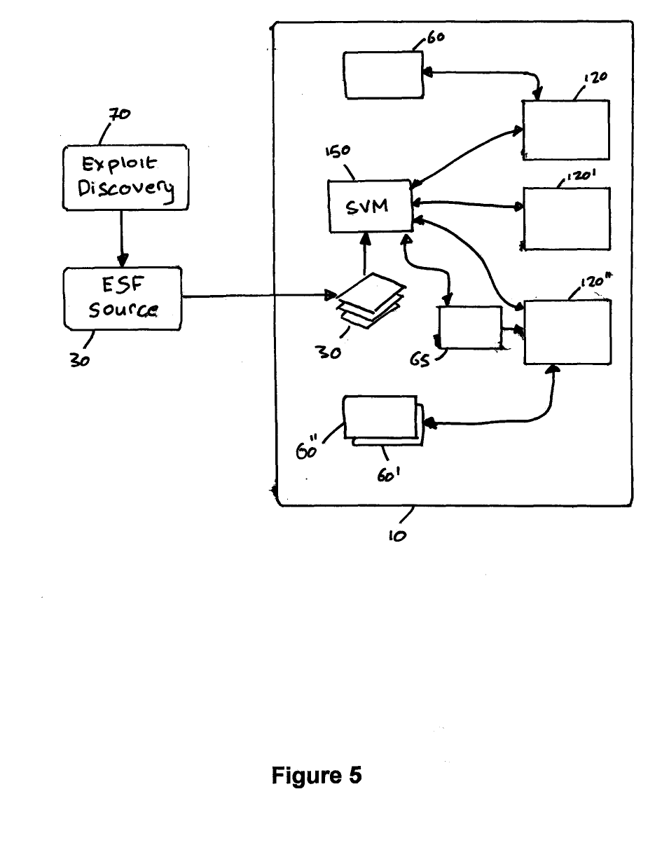

Although in embodiments described above the SVM 50 is deployed in a secured core of the software application 10, in other embodiments a similar SVM 150 could be deployed separately from the software application 20 and used to protect one or more software applications 120, 120′, 120″, as illustrated in FIG. 5. This may be done even if two or more of the plurality of software applications 120, 120′, 120″ have each been developed by different parties. Any such applications could be protected by encrypting them (or parts of them) in such a manner that only the external SVM 150 could carry out the required decryption. Before any such software application could be run, the SVM 150 would verify that the applications 120, 120′, 120″ have not been tampered with and that no known exploits are currently deployed on the computer device 10, for instance that no dependent libraries 60, 60′, 60″ have been changed by a known exploit. If the computer device 20 is found by the scan to be clear of exploits, then the software application is decrypted and started.

While a software application 120, 120′, 120″ is running in association with an external SVM 150, the SVM 150 should preferably continue to scan and verify that known exploits are not being used or started. Preferably, any such application 120, 120′, 120″ should require that the external SVM 150 continues to function so that an attacker could not simply stop the corresponding process or thread. This could be achieved, for instance as shown in FIG. 5, by including one or more additional files or resources 65 which are need by an application 120″, but which are maintained in an encrypted state, and are only decrypted by the SVM 150 on completion of a successful scan. Alternatively or additionally, an application 120, 120′, 120″ could be arranged perform a check that the external SVM 150 is running correctly, and to reduce or cease usual functionality if the SVM process 150 stopped or became ineffective in scanning the application.

There now follows a discussion of techniques which can be used to provide the secured core 40 above in which the system verification module 50 may be executed. When a program (or software) is being executed by a processor, the environment in which the execution is being performed is a so-called “white-box” environment if the user (or a third party) has access to the processing so that the user can observe and alter the execution of the program (e.g. by running a suitable debugger)—such alterations could be changes to the process flow or changes to the data being processed. This observation and/or alteration of the execution of the program may be referred to as tampering. The user may observe or alter (or in other words tamper with) the execution of the program in order to satisfy their own aims or goals, which may not be possible to satisfy if the program were to run normally without being tampered with. Such tampering to achieve a particular aim or goal may be referred to as goal-directed tampering. Goal-directed tampering may involve, for example, observing and/or altering the execution of a program being run in a white-box environment in order to obtain or deduce a cryptographic key that is used by the program to process digital data (e.g. a decryption key for decrypting data).

Various techniques are known for protecting the integrity of a data processing software application (or program or system) which is being run in a white-box environment. These techniques generally aim to hide the embedded knowledge of the application by introducing additional complexity and/or randomness in the control and/or data paths of the software application. This additional complexity and/or randomness has the effect of obscuring or obfuscating the information (or data) or execution path of the software application. As a result of this obfuscation, it becomes more difficult to extract information from the application by code inspection and it is more difficult to find and/or modify the code that is associated with particular functionality of the program. It is therefore much more difficult for an attacker with access to the program running in a white-box environment to retrieve sensitive data or alter the operation of the program in order to meet their own goals by tampering with the execution of the program. As such, the ability of the attacker to carry out goal-directed tampering is reduced. These techniques which aim to reduce the ability of an attacker to carry out goal-directed tampering may be considered to improve the tamper-resistance of the software. If it is sufficiently difficult for an attacker to carry out goal-directed tampering, then, for any practical purposes, the software may be considered to be tamper-resistant, even if theoretically tampering is still possible.

An exemplary technique for improving the tamper-resistance of software can be found in “White-Box Cryptography and an AES Implementation”, by Stanley Chow, Philip Eisen, Harold Johnson, and Paul C. Van Oorschot, in Selected Areas in Cryptography: 9^{th} Annual International Workshop, SAC 2002, St. John's, Newfoundland, Canada, Aug. 15-16, 2002, the entire disclosure of which is incorporated herein by reference. “White-Box Cryptography and an AES Implementation” discloses an approach to protecting the integrity of a cryptographic algorithm by creating a key-dependent implementation of the algorithm using a series of lookup tables. The key(s) are embedded in the implementation by partial evaluation of the algorithm with respect to the key(s). Partial evaluation means that expressions involving the key are evaluated as much as reasonably possible, and the result is put in the code rather than the full expressions. This means that the implementation is specific to particular key(s) and that key input is unnecessary in order to use the key-dependent implementation of the algorithm. It is therefore possible to distribute a key-dependent implementation of an algorithm, which may be user-specific, for encrypting or decrypting content or data instead of distributing keys, which may be user-specific. The key-dependent implementation is created so as to hide the key(s) by: (1) using tables for compositions rather than individual steps; (2) encoding these tables with random bijections; and (3) extending the cryptographic boundary beyond the cryptographic algorithm itself further out into the containing application, thereby forcing attackers to understand significantly larger code segments to achieve their goals.

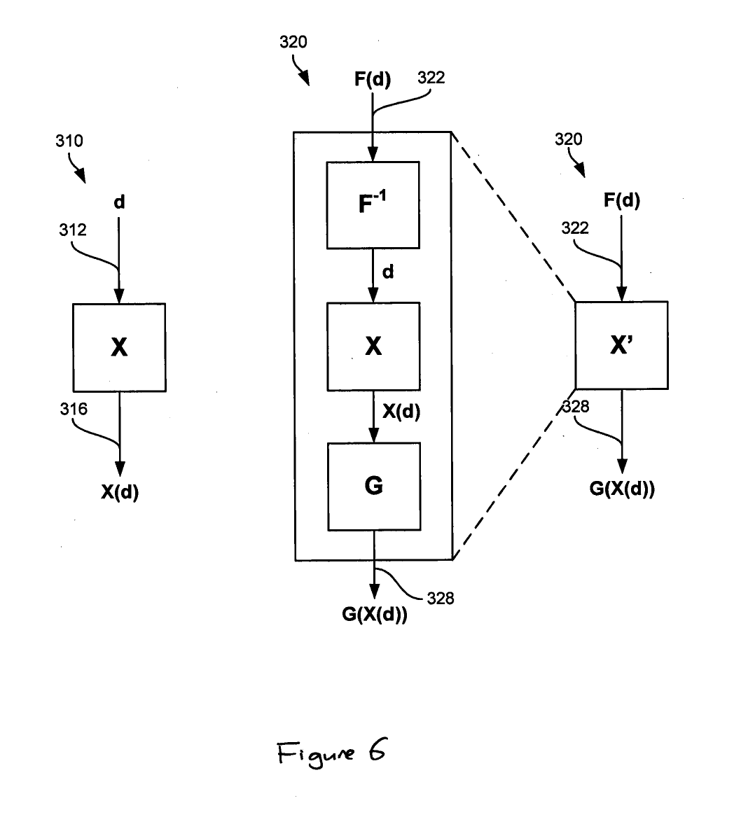

FIG. 6 of the accompanying drawings illustrates an implementation 310 of an exemplary function X which receives or obtains data d at, or via, an input 312 to the function X, processes the data d to generate processed data X(d), and provides the processed data X(d) via an output 316. The implementation 310 of the function might involve one or more processing steps which comprise one or more of instructions, code, logic, lookup tables or any combination thereof in order to provide the processed data X(d) at the output 316 in response to receiving data d at the input 312. FIG. 6 further illustrates an encoded or obfuscated implementation 320 of the function X—this implementation 320 comprises an obfuscated function X′. In the implementation 320, the function X is obfuscated to form the function X′ by using an input encoding F and an output encoding G. The obfuscated function X′ receives or obtains an encoded representation F(d) of the input data d at, or via, an input 322 to the obfuscated function X′, processes the encoded representation F(d) to generate an encoded representation G(X(d)) of the processed data X(d), and provides the encoded representation G(X(d)) via an output 328. The encoded representation F(d) is the data d encoded using the function F. The encoded representation G(X(d)) is the data X(d) encoded using the function G. The obfuscated function X′ can be considered as:

X′=G∘X∘F⁻¹

where ∘ denotes function composition as usual (i.e. for any two functions a(x) and b(x), (a∘b)(x)=a(b(x)) by definition). The functions F⁻¹, X, G are obfuscated in the implementation by combining them into a single lookup table. This combination of the functions into a single lookup table means that as long as the functions F and G remain unknown to an attacker, the attacker cannot extract information about the function X and hence cannot, for example, extract secret information (such as a cryptographic key) that is the basis for, or that is used by, the function X. Whilst the middle of FIG. 6 illustrates the obfuscated function X′ as the series of functions F⁻¹, X and G, this is merely for the purpose of illustration.

In particular, the obfuscated function X′ does not implement each of the functions F⁻¹, X and G separately (as to do so would expose the data d and X(d) and the operation of the function X to an attacker)—instead, as mentioned above, the functions F⁻¹, X and G are implemented together as a single function (such as via a look-up table), so that the obfuscated function X′ does not expose the data d and X(d) to an attacker and does not expose the processing or operation of the function X to an attacker.

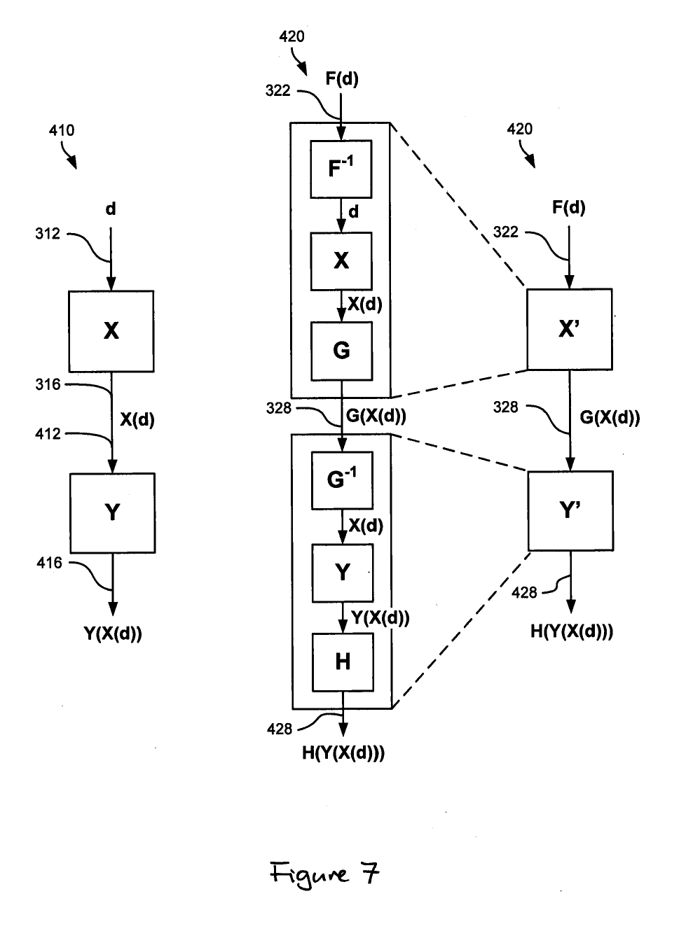

Any given program can be thought of as a sequence or network of functions. FIG. 7 of the accompanying drawings illustrates an exemplary implementation 410 of a program or part of a program whereby two functions X and Y are to be evaluated sequentially (i.e. as part of a sequence) in order to provide the operation:

(Y∘X)(d)=Y(X(d))

In other words, the sequence of functions receives or obtains data d at, or via, an input 312 to the first function in the sequence, namely the function X, the function X then processes the data d to generate processed data X(d) and provides the processed data X(d) via an output 316, as discussed above. The processed data X(d) is provided via the output 316 of the first function X to an input 412 of the second function in the sequence of functions, namely the function Y, the function Y then processes the data X(d) to generate processed data Y(X(d)) and provides the processed data Y(X(d)) via an output 416. In this manner, the processed data Y(X(d)) provided at the output 416 of the second function Y is provided as the output from the sequence of functions X and Y. Again, each of the functions X and Y can respectively be implemented as one or more of instructions, code, logic or lookup tables or any combination thereof, as discussed above. However, when the implementation 410 of the sequence of functions X and Y is executed in a white-box environment, an attacker can observe and/or modify one or more of: the operation of each of the functions X and Y; the data d provided to the input 312 of the sequence of functions; the processed data Y(X(d)) provided at the output 416 of the sequence of functions; and the processed data X(d), which is provided to the input 412 of the second function Y from the output 316 of the first function X. Therefore, when the sequence of functions X and Y is executed as the implementation 410 in a white-box environment, the operation provided by that sequence of functions is susceptible to tampering. Where the implementation 410 of the sequence of functions X and Y form a key-dependent implementation of a cryptographic component for a program, for example, it may be possible for an attacker to extract or deduce a cryptographic key by observing or tampering with the functions X and/or Y and/or the data that is provided to/between them. To overcome this problem, the functions X and Y in the sequence of functions X and Y can be implemented as obfuscated versions X′ and Y′ of those functions X and Y respectively.

FIG. 7 further illustrates such an encoded or obfuscated implementation 420 of the sequence of functions X and Y—the implementation 420 comprises an obfuscated function X′ and an obfuscated function Y′. In the implementation 420, the obfuscated function X′ of the function X is formed by combining the function X with an input encoding F and an output encoding G, as described earlier in relation to FIG. 6. The obfuscated function Y′ of the function Y is formed in a similar manner to the obfuscated function X′, albeit that the input encoding G and output encoding H that are used for the implementation of obfuscated function Y′ may differ from the input encoding F and the output encoding G that are used for the implementation of obfuscated function X′. The obfuscated implementation Y′ of function Y can therefore be represented as:

Y′=H∘Y∘G⁻¹

The input encoding G used with obfuscated function Y′ should match the output encoding G used with the obfuscated implementation of the preceding function X′. This means that the representation of the processed data G(X(d)) provided at the output 328 of the obfuscated function X′ using the output encoding G can be used as the input to the obfuscated function Y′ which expects to receive the data X(d) represented using input encoding G (i.e. it expects to receive G(X(d))). It will be appreciated that whilst the function G is referred to as being the input encoding for the obfuscated function Y′ (since the data X(d) that is to be received at the input 328 to the obfuscated function Y′ is encoded with the function G such that it is the encoded representation G(X(d)) of the data X(d)), the actual function that is combined with the function Y to implement the obfuscated function Y′ is the inverse of the function G, namely the function G⁻¹, which has the effect of cancelling out the input encoding G to allow the operation of the function Y on the data X(d).

The obfuscated function Y′ receives the data X(d) represented as G(X(d)) (i.e. encoded by the function G) from the output 328 of obfuscated function X′. The obfuscated function Y′ processes the encoded representation G(X(d)) of the processed data X(d) to generate an encoded representation H(Y(X(d))) of the processed data Y(X(d)), and provides the encoded representation H(Y(X(d))) via output 428. Since the obfuscated function Y′ is the last function in the sequence of functions, the output 428 of the obfuscated function Y′ is the output of the obfuscated implementation 420 of the sequence of functions.

Again, whilst the middle of FIG. 7 illustrates the obfuscated function Y′ as the series of functions G⁻¹, Y and H, this is merely for the purpose of illustration. In particular, the obfuscated function Y′ does not implement each of the functions G⁻¹, Y and H separately (as to do so would expose the data X(d) and Y(X(d)) and the operation of the function Y to an attacker)—instead, as mentioned above, the functions G⁻¹, Y and H are implemented together as a single function (such as via a look-up table), so that the obfuscated function Y′ does not expose the data X(d) and Y(X(d)) to an attacker and does not expose the processing or operation of the function Y to an attacker.

It will be appreciated that in order for the representation of the output H(Y(X(d))) of the obfuscated implementation 420 of the sequence of functions to be correctly calculated, the input d to the implementation 420 must be represented as F(d) using the input encoding of the first obfuscated function in the sequence of obfuscated functions (i.e. F), whilst the output encoding of each obfuscated function in the sequence (except for the last obfuscated function in the sequence) must match the input encoding of the next function. The output encoding of the last obfuscated function in the sequence (i.e. H) dictates the representation of the output that is provided from the obfuscated sequence of functions (i.e. H(Y(X(d)))).

The obfuscated implementation 420 of the sequence of functions X and Y can therefore be represented as:

Y′∘X′=(H∘Y∘G⁻¹)∘(G∘X∘F⁻¹)=H∘(Y∘X)∘F⁻¹

In this way, Y∘X is properly computed albeit that the input d needs to be encoded with the function F and the output H(Y(X(d))) needs to be decoded with the function H⁻¹. Each obfuscated function X′ and Y′ can be separately represented in respective lookup tables, such that the functions H, Y and G⁻¹ are combined in a table implementing the obfuscated function Y′ and the functions G, X and F⁻¹ are implemented in a different table implementing the obfuscated function X′. By combining the functions into single lookup tables in this manner, the details of the functions X and Y, the data they operate on and output, as well as functions F, G and H are hidden. Meanwhile, the data X(d) that is passed between the lookup tables in the obfuscated implementation 420 is represented using the encoding G (i.e. as G(X(d))). This means that an attacker cannot observe any useful information in the data flows between the obfuscated functions in the obfuscated implementation 420.

The representation of the output G(X(d)) that is provided from the sequence of obfuscated functions will correspond to the output X(d) of the sequence of non-obfuscated functions encoded by the function G, assuming that the input data d is provided to the obfuscated sequence of functions represented as F(d) (i.e. encoded by the function F) and that no errors occur during processing.

The use of input and output encodings for the obfuscated implementation 420 of the sequence of functions has the effect that the obfuscated functionality is bound more tightly into the rest of the program or system in which implementation 420 operates. This is because the functions in the rest of the program or system which provide data to (or call) the obfuscated sequence of functions, provides a representation of the data encoded using the input encoding F, whilst the functions in the rest of the program or system which receive data from the obfuscated sequence of functions receive a representation of the processed data encoded using the output encoding H. Therefore, the effect of the obfuscation extends the code which an attacker would have to understand beyond the sequence of functions themselves into the surrounding functions or parts of the program. In the case where the obfuscated implementation 420 is a cryptographic component of a program, which will commonly be part of a larger containing system or application, the use of input and output encodings has the effect of extending the cryptographic boundary beyond the cryptographic algorithm itself further out into the containing system or application. This makes it harder to extract a key-specific implementation of the cryptographic algorithm from the rest of the application and forces an attacker to understand larger parts of the code in order to tamper with the software, thereby making the software harder to tamper with.

Although FIGS. 6 and 7 illustrate obfuscated functions which have both input and output encodings applied to them, it will be appreciated that it is possible to obfuscate a function by only combining either an input or an output encoding with the function. As an example, although not illustrated in FIG. 4, the obfuscated function X′ could be implemented so that it uses an output encoding G, but not input encoding F. Similarly, the obfuscated function Y′ could be implemented so that it uses an input encoding G, but not output encoding H. This arrangement can be represented as:

Y′∘X′=(Y∘G⁻¹)∘(G∘X)=Y∘X

As a result, the input to the sequence of obfuscated functions could be the data d, which is the same representation of the input as would be provided to the non-obfuscated sequence of functions, and the output of the sequence of obfuscated functions would be Y(X(d)), which is the same representation of the output that would be provided by the non-obfuscated sequence of functions. However, the sequence of functions is still obfuscated in so far as an attacker is unable to observe the result of function X or the input of function Y. Therefore, provided that the details of the function G are unknown to the attacker, it will still be hard for an attacker to ascertain the details of these functions in order to extract a key.

Whilst FIG. 7 illustrates a sequence of two function X and Y that are then implemented as obfuscated functions X′ and Y′, it will be appreciated that any number of functions (in a series, network, chain, etc.) could be implemented as a series, network, chain, etc. of corresponding obfuscated functions.

It will be understood that variations and modifications may be made to the described embodiments without departing from the scope of the invention as defined in the appended claims. For example, it is to be understood that any feature described in relation to any one embodiment may be used alone, or in combination with other features described in respect of that or other embodiments.

1. A method of executing a software application on a device, comprising:
providing the software application with a secured core;
receiving, at the device, exploit signature data from a source external to the device; and
executing a system verification function within the secured core, the system verification function being arranged to scan, using the exploit signature data, for exploits against the software application.

2. The method of claim 1 wherein the system verification function, in combination with the exploit signature data, is arranged to scan only for exploits against the software application, and not for exploits against other software applications.

3. A method of executing at least one software application installed on a computer device, comprising:
receiving, at the device, exploit signature data from a source external to the device; and
executing a system verification function on the computer device to scan for exploits against at least one of the at least one software application.

4. The method of any preceding claim wherein the software application is arranged such that using an exploit to bypass the system verification function causes a limitation in the user functionality of the software application.

5. The method of any preceding claim wherein the software application is arranged to make a procedure call to a library function within the device but external to the software application, and the system verification function is arranged to perform a scan for exploits against the software application before completing the procedure call and to block completion of said procedure call if an exploit against the software application is detected by the scan.

6. The method of any preceding claim wherein the system verification function is arranged to perform a scan for exploits against the software application before decrypting selected data required by the software application, and to block completion of said decryption if an exploit against the software application is detected by the scan.

7. The method of any preceding claim wherein the exploit signature data is received at the device as at least one exploit signature file.

8. The method of claim 7 wherein the exploit signature data is encrypted within the received exploit signature file, and the system verification function is arranged to decrypt the exploit signature data before use in performing a scan for exploits against the software application.

9. The method of claim 7 or 8 wherein the exploit signature file comprises a time stamp, and the system verification function is arranged to determine whether or not to use the exploit signature data contained within the exploit signature file dependent upon the time stamp.

10. The method of any of claims 7 to 9 wherein the exploit signature file comprises a digital signature, and the system verification function is arranged not to use the received exploit signature file to perform a scan for exploits against the software application if the system verification function fails to verify the digital signature.

11. The method of any of claims 7 to 10 wherein the device is arranged to periodically receive updated versions of the exploit signature file from an external server.

12. The method of any preceding claim where the exploit signature data identifies only local exploits against the software application.

13. The method of any preceding claim wherein the exploit signature data provides the system verification function with one or more algorithms for use in scanning for said exploits.

14. The method of any preceding claim wherein the exploits comprise one or more exploits for obtaining cryptographic key data from the software application.

15. The method of any preceding claim wherein the device is a mobile computing device.

16. A computer device comprising:
a software application provided with a secured core; and
a system verification function arranged to execute within the secured core of the software application to scan for exploits against the software application,
the computer device being arranged to receive exploit signature data from a source external to the device, the system verification function being arranged to use the exploit signature data to scan for said exploits.

17. The computer device of claim 16 wherein the software application is arranged such that using an exploit to bypass the system verification function causes a limitation in the user functionality of the software application.

18. The computer device of claim 16 or 17 wherein the software application is arranged to make a procedure call to a library function within the device but external to the software application, and the software application is arranged to perform a scan for exploits against the software application before completing the procedure call and to block completion of said procedure call if an exploit against the software application is detected by the scan.

19. A computer readable medium comprising computer program code arranged to put into effect the method of any of claims 1 to 15 when executed on suitable computer device.
